(19) United States
(12) Patent Application Publication
(10) Pub. No.: US 2023/0126304 A1
(43) Pub. Date: Apr. 27, 2023

(54) METHOD FOR DEVELOPING SECURE AND RELIABLE AUGMENTED REALITY APPLICATIONS

(71) Applicant: HAVELSAN HAVA ELEKTRONIK SAN. VE TIC. A. S., Ankara (TR)

(72) Inventors: Cem Murat TURGUT, Ankara (TR); Resul AYDOGAN, Ankara (TR); Mesut GOZUTOK, Ankara (TR)

(73) Assignee: HAVELSAN HAVA ELEKTRONIK SAN. VE TIC. A. S., Ankara (TR)

(21) Appl. No.: 17/800,551

(22) PCT Filed: Feb. 18, 2021
(86) PCT No.: PCT/TR2021/050153

§ 371 Date: Aug. 18, 2022

(30) Foreign Application Priority Data
Feb. 19, 2020 (TR) 2020/02540

(51) Int. Cl. G06F 21/53

(52) U.S. Cl. CPC G06F 21/53; G06F 2221/033

(57) ABSTRACT

Provided are a method for safely and reliably designing augmented reality (AR) applications on at least one server and at least one augmented reality device connected to each other and a network structure consisting of at least one server and at least one augmented reality device connected to each other. The method proposes a platform for developing and running augmented reality applications. Accordingly, at least two users can use the method to develop an AR application, to modify an AR application or run a ready application. The method prevents information leakage by calling some elements from TEE with asymmetric cryptography and safely operates a reliable system. In this way, the method provides a secure environment since third party access to asymmetric passwords is prevented.

### CROSS REFERENCE TO THE RELATED APPLICATIONS

This application is the national stage entry of International Application No. PCT/TR2021/050153, filed on Feb. 18, 2021, which is based on Turkish Patent Application No. 2020/02540, filed on Feb. 19, 2020, the entire contents of which are incorporated herein by reference.

### TECHNICAL FIELD

The method of the invention is a method designed to operate on at least one computer and offers a solution to the problem of creating a secure and reliable platform for developing augmented reality applications. In this respect, it is a new proposal for platforms created for developing augmented reality applications and running the developed applications in real time.

### BACKGROUND

In the prior art, many studies are conducted on application development servers for virtual reality and similar (AR) fields. These are mainly server structures that allow more than one person to develop in coordination. Because the development of an AR application takes time and many tests are needed, while a team must constantly develop on a server. Moreover, since the development steps such as scenario changes, command and management changes and updates are not completed after the development phase, the total development time on the server becomes equal to the life time of the product. Some of the remarkable studies on this subject are;

In the U.S. Patent numbered US9804813, a computer infrastructure for developing AR applications is mentioned. Accordingly, the mentioned mechanism is related to a method that covers the object directly on the markers and instantly captures and prints on the AR device. It was not considered to be similar since it does not provide a reliable structure, does not allow multiple working, and does not offer a development environment suitable for multiple work. In the U.S. Patent Numbered US9679152, a mechanism designed to secure a certain transaction — for example withdrawal — is mentioned. Accordingly, the server generates a code and sends it to the AR device cryptically and thus presented to the user. Moreover, user authentication is performed through glasses. However, since it does not provide a development environment, does not contain TEE components and it does not provide a secure operation, it is not considered to be similar.

PCT Application Numbered WO2014012040 proposes a server structure based on receiving information from the device camera, even if the camera is turned off, and calling this information from the device via TEE. However, this user structure is not suitable for multi-user development and it is vulnerable to server-side security vulnerabilities.

In this respect, since the proposed method chooses to install the security protocol where the minimum information is stored instead of protecting the place where the main information is stored, the development security is not in question. When the security barrier of the developer side falls, there is no point in a single device being safe as the total system security is compromised. Since a third party leaking into the system can see all of the sent keys and passwords, since it controls the way communication is provided. Moreover, since asymmetric cryptography and multi-developer support are not mentioned, it was not considered to be similar to the method of the invention.

### SUMMARY

The method of the invention proposes a platform for developing and running augmented reality applications. Accordingly, at least two users can use the method of the invention to develop an AR application, to modify an AR application or run a ready application. The method of the invention prevents information leakage by calling some elements from TEE with asymmetric cryptography and safely operates a reliable system. In this way, it provides a secure environment since third party access to asymmetric passwords is prevented.

### DETAILED DESCRIPTION OF THE EMBODIMENTS

The method of the invention was first designed to operate on a server. From the point of the art, this server can be a server consisting of more than one computer in a distributed structure, or it can be a cloud server or a similar structure. In terms of the method according to the invention, any one that can perform the operations sequentially and is capable of sending commands functions as a total server; the trade name, form or number of parts does not matter.

Throughout the specification, AR is used as an abbreviation to refer to augmented reality units. However, AR term is used to refer to augmented reality glasses, virtual reality apparatus, mixed reality devices and augmented reality devices without glasses (for example, tablet, lens, etc.). Here, display units that provide images to the restrictive user, receive this image from a center and transfer user data (for example, direction, position, etc.) to the server with some sensors are mentioned. The method of the invention begins with the request of the AR equipment to communicate with another AR equipment or hardware. Then, TEE area is activated on this AR equipment. AR creates a Public key and a private key on the hardware. The public key generated by the hardware is stored on a server or an authority.

Likewise, other AR hardware generates their own private and public keys and stores their public keys on a reliable server or authority. The device that creates a mutual data transmission request receives the public key of the device from which it requests to send data from the server. Then, it generates a new key for symmetric messaging. It encrypts this symmetric key with the other party’s public key and its own private key and sends it to the endpoint to be transferred. It separates the other endpoint encryption key from the message and reveals the symmetric key to be used for data transfer. All these operations are performed in the TEE area and all keys are stored in the TEE area on the AR hardware. After all endpoints obtained the symmetric encryption key, this key is used to encrypt the data into the TEE field. Data encrypted with the encryption key is sent over the server to other endpoints. Each endpoint opens the incoming data in the TEE area using the encryption key it hosts in its own TEE area. This data is then displayed to the user on the AR hardware. For symmetric encryption using this key and its own private key, the public key is sent over the server to other hardware in which application will be shared on the server. Likewise, other AR hardware is put on the server and AR Reliable server or authority. The communication between the glasses starts with a TEE area opened by the server. Accordingly, the server creates a secure area on itself and creates a public key, a private key and a symmetric encryption key for each endpoint within this secure area. When the key generations are complete, it sends these keys to the AR units. After this point, each AR receives the keys sent and saves them for hosting in a TEE field it opens on itself. It keeps the TEE area open for encryption and decryption operations and executes these two operations in the secure area from beginning to end. Moreover, AR units generate their own keys and send them to the other party, and these passwords are stored in the TEE area on the opposite side. Thus, it is ensured that all passwords and keys are stored in a secure area. Since all areas (server and AR) also carry out decryption in the TEE area, it is not possible to access passwords from outside.

Even if there is a leak from the device and the network to some parts, the server will be useless as it does not cover access to these leaked passwords.

After this stage, the data transferred to the augmented reality application over the secure area is displayed to the user on augmented reality application devices such as glasses, tablets, phones, etc. On platforms that support TEE and Reliable User Interface, the augmented reality application representation is provided to the user through the reliable user interface.

If at least one of the server or AR units is hardware that does not support TEE, a similar security is provided with white box cryptography.

TEE, used as a term throughout the specification, is a commonly used term in the art for the Trusted Execution Environment.

This is the general name given to create a second execution environment that is not accessible from the outside by creating an area on a device.

In this respect, it opens an area as if two different operating systems are running on a single hardware, calls the hardware from here and sends data from the rich environment (from the device other than TEE).

In this way, it is essential to create an area that is not connected to the network and cannot be accessed from outside.

In this way, a secure area is created and used.

The method of the invention increases the security of the AR development servers and devices by using TEE increasing the safety of users and thus provides a secure and reliable communication in the transportation of military data as well as banking, finance and other sensitive areas.

Thus, it increases security by providing a platform for the encryption of the parties’ own sensitive data.

What is claimed is:

1. A method for safely and reliably designing augmented reality (AR) applications on at least one server and at least one augmented reality device connected to each other, comprising:
a. transmitting a communication request with second AR hardware of first AR hardware to the server; immediately activating a trusted execution environment (TEE) area on a sending and receiving device; generating public and private keys on the sending and receiving device; and execution of the following steps in the TEE area;
b. transferring of the public key through the server;
c. repeating steps (a) and (b) for all AR devices sending communication requests;
d. a device sending a request for mutual data transmission receives the public key of the sending and receiving device, wherein the device requests to send from the server to the sending and receiving device;
e. creating a special symmetric key for the device, wherein data is sent to the device;
f. encrypting and sending the special symmetric key with the public key of the sending and receiving device, wherein the device wants to send the data and an own private key of the device to the sending and receiving device;
g. opening the data in the TEE area on receiving AR hardware;
h. presenting the data to a user;
i. enabling users to develop applications in a secure area on a server by repeating steps (a)-(i) for next data to be sent.

2. A network structure consisting of at least one server and at least one augmented reality device connected to each other, wherein the network structure is configured to implement the following steps:
a. transmitting a communication request with second AR hardware of first AR hardware to the server; immediately activating a TEE area on a sending and receiving device; generating public and private keys on the sending and receiving device ; and execution of the following steps in the TEE area;
b. transferring of the public key through the server;
c. repeating steps (a) and (b) for all AR devices sending communication requests;
d. a device sending a request for mutual data transmission receives the public key of the sending and receiving device, wherein the device requests to send from the server to the sending and receiving device;
e. creating a special symmetric key for the device, wherein data is sent to the device;
f. encrypting and sending the special symmetric key with the public key of the sending and receiving device, wherein the device wants to send the data and an own private key of the device to the sending and receiving device;
g. opening the data in the TEE area on receiving AR hardware;
h. presenting the data to a user;
i. being configured to repeat steps (a)-(i) sequentially for next data to be sent.
